(19) United States
(12) Patent Application Publication
(10) Pub. No.: US 2026/0230218 A1
(43) Pub. Date: Aug. 6, 2026

(54) EVALUATING AND DISPLAYING INFORMATION FOR IMPROVED COMMUNICATION CHANNEL

(71) Applicant: Telefonaktiebolaget LM Ericsson (publ), Stockholm (SE)

(72) Inventors: Stefan ADALBJÖRNSSON, HJÄRUP (SE); Alexander HUNT, TYGELSJÖ (SE); Joao VIEIRA, HJÄRUP (SE)

(21) Appl. No.: 19/154,794

(22) PCT Filed: Jun. 19, 2023
(86) PCT No.: PCT/SE2023/050616

§ 371 Date: Aug. 8, 2025

Related U.S. Application Data
(60) Provisional application No. 63/448,883, filed on Feb. 28, 2023.

(51) Int. Cl. H04L 1/00; G06F 3/01

(52) U.S. Cl. CPC H04L 1/0017; G06F 3/012; H04L 1/0026

(57) ABSTRACT

A method is provided performed by a mobile device for evaluating and displaying information for an improved communication channel between the mobile device and a network node. The method includes evaluating whether a decrease in a quality of the communication channel is based on a first variance of a first signal that indicates a variance in the quality of the communication channel and a second variance of a second signal that indicates a variance in a pose of the mobile device. The method further includes displaying the information including at least one of (i) an indicator showing how to change a current pose of the mobile device, and (ii) a position for the mobile device that satisfies a specified quality for content to be displayed on the user interface of the mobile device in the position.

### TECHNICAL FIELD

The present disclosure relates to evaluating and displaying information for an improved communication channel between a mobile device (such as extended reality (XR) glasses) and a network node, and related methods and devices.

### BACKGROUND

In 2030, the expected number of XR, augmented reality (AR), and/or virtual reality (VR) devices may reach one billion.

A large potential for mass-market adaptation may exist for various kinds of such mobile devices that overlay digital objects or information over the real physical world. Such mobile devices may need to be lightweight, and offloading of computations may be important. Thus, such mobile devices may need a high downlink throughput and a low bounded round-trip time.

Mobile devices also may enable an increased use of three-dimensional (3D) content, e.g., new immersive media formats and codecs with requirements as high as about 100 Mbps or more in downlink and about 50 Mbps in uplink or more, depending on hardware offloading schemes. Streaming of traditional media format also may be a use case with requirements exceeding about 25 Mbps. Low latency and high reliability of applications from a communication network also may have increasing importance, e.g., for XR to have a high quality of experience (QoE).

### SUMMARY

There currently exist certain challenges. Decreased channel coherence time associated with head movements/rotations of a user wearing a mobile device, such as an XR, AR, or VR device, may lead to a reduced quality of experience for the user. Rapid head movements, for example, particularly may lead to a reduced quality of experience.

Certain aspects of the disclosure and their embodiments may provide solutions to these or other challenges. During normal operation, a mobile device can collect/access (e.g., continuously) communication channel key performance indicators (KPIs) of previously visited positions and orientations of the mobile device. If a decrease in quality of the communication channel is detected by the mobile device, a visualization/display in the mobile device is shown where the user can turn the user's head/mobile device to attain better channel quality. By showing the user where to go or look for better quality channel, the challenge of varying channel conditions due to mobile device user head movements/rotations may be mitigated including, without limitation, by a display of an indication on the UI that, by looking at the indication, “forces” the user of the mobile device to move in a direction that can improve the quality of the channel.

Some embodiments disclosed herein are directed to a method performed by a mobile device for evaluating and displaying information for an improved communication channel between the mobile device and a network node. The method includes evaluating whether a decrease in a quality of the communication channel is based on a first variance of a first signal that indicates a variance in the quality of the communication channel and a second variance of a second signal that indicates a variance in a pose of the mobile device The first variance and the second variance vary together. The method further includes displaying, on a user interface of the mobile device, the information including at least one of (i) an indicator showing how to change a current pose of the mobile device, and (ii) a position for the mobile device that satisfies a specified quality for content to be displayed on the user interface of the mobile device in the position.

Some other embodiments are directed to a mobile device for evaluating and displaying information for an improved communication channel between the mobile device and a network node. The mobile device includes at least one processor; and at least one memory storing instructions executable by the at least one processor to perform operations to evaluate whether a decrease in a quality of the communication channel is based on a first variance of a first signal that indicates a variance in the quality of the communication channel and a second variance of a second signal that indicates a variance in a pose of the mobile device. The first variance and the second variance vary together. The operations further include to display, on a user interface of the mobile device, the information including at least one of (i) an indicator showing how to change a current pose of the mobile device, and (ii) a position for the mobile device that satisfies a specified quality for content to be displayed on the user interface of the mobile device in the position.

Some other embodiments are directed to a computer program product including a non-transitory computer readable medium storing instructions executable by at least one processor of a mobile device for evaluating and displaying information for an improved communication channel between the mobile device and a network node. The instructions executed by the at least one processor perform operations including to evaluate whether a decrease in a quality of the communication channel is based on a first variance of a first signal that indicates a variance in the quality of the communication channel and a second variance of a second signal that indicates a variance in a pose of the mobile device. The first variance and the second variance vary together. The operations further include to display, on a user interface of the mobile device, the information including at least one of (i) an indicator showing how to change a current pose of the mobile device, and (ii) a position for the mobile device that satisfies a specified quality for content to be displayed on the user interface of the mobile device in the position.

Certain embodiments may provide one or more of the following technical advantage(s). As a consequence of the evaluating and displaying information, quality of a communication channel may be improved by making an adjustment to the position and/or orientation of the mobile device, which may counteract a decrease in performance of the communication channel due to spatially varying channel conditions.

Other methods, mobile devices, and computer program products according to embodiments will be or become apparent to one with skill in the art upon review of the following drawings and detailed description. It is intended that all such additional mobile devices, methods, and computer program products be included within this description and protected by the accompanying claims.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of components of a mobile device that are configured to operate according to some embodiments;

FIG. 2 is a flow chart illustrating operations of a mobile device according to some embodiments; and

FIG. 3 is a schematic illustrating movement and poses of a mobile device according to some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of the present disclosure are shown. Inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

Channel coherence time may be a challenge for XR devices, for example, as a consequence of head movements/rotations of a user wearing a XR device (e.g., glasses or a headset). Head movements/rotations may cause a wireless link to go from line-of-sight (LOS) to non-LOS. Such head movements/rotation may decrease channel coherence time by one or two orders of magnitude compared to channel coherence time associated with more static wireless devices (e.g., user equipments (UEs)). For example, this challenge may be present especially at frequency range 2 (FR2), which includes frequencies above 24.250 GHz for fifth generation (5G) new radio (NR) due to the nature of FR2 transmissions and receptions which are particularly directive in nature. Thus, not only channel coherence time may decrease, but the link for communications also may go from reliable to unreliable.

As previously indicated, decreased channel coherence time associated with head movements/rotations of a user wearing a mobile device may lead to a reduced quality of experience for the user. Certain aspects of the present disclosure and their embodiments may counteract variances in the quality of the communication channel between a mobile device and network node due to such movements of the mobile device.

In some examples, a mobile device stores pose information and respective KPIs for respective poses such that when a KPI is not fulfilled, the stored data can be searched to a find prior pose(s) where the KPI was fulfilled. Such a search of prior poses can be performed when a change in the KPI can be correlated with a change (e.g., a large or sudden change) in the pose of the mobile device. A subset of the poses, satisfying a criteria/threshold of closeness in time or space, can be visualized/displayed in the mobile device to guide a user of the mobile device towards a location, area, and/or orientation where the KPI may be met.

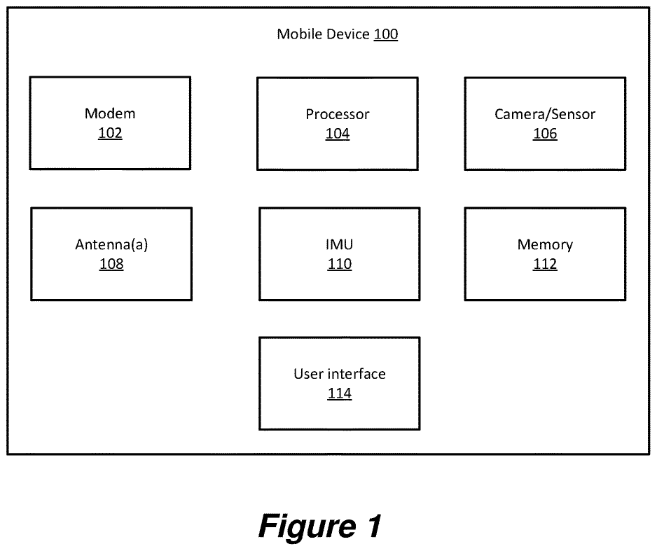

FIG. 1 is a block diagram of components of a mobile device 100 that is configured to operate according to some embodiments. As discussed further herein, mobile device 100 includes modem 102, at least one processor 104, sensor 106 (including, without limitation, a camera, light detection and ranging (lidar), radar, time of flight (ToF) infrared (IR) sensor, etc.) that can collect data to obtain environmental knowledge (such as, position, pose, features, etc.), antenna(s) 108, inertial movement unit (IMU) 110, at least one memory 112, and a user interface 114. Non-limiting examples of user interfaces include viewing screens, touch screens, and other display devices that can display content and/or indicators (as discussed further herein), user selectable menus, and physical buttons, touch sensor interfaces, etc.

As shown in FIG. 1, the mobile device 100 can include a modem 102. The modem may be manufactured by the same entity that manufactures the mobile device 100, or by a different entity than the manufacturer of the mobile device and integrated into the mobile device 100. Modem 102 may be a third generation partnership project (3GPP)-compatible new radio (NR) chipset or a WiFi chipset, for example, that is embedded in the mobile device 100 (e.g., embedded in XR glasses). An interface between mobile device 100 and modem 102 may be limited when, for example, the mobile device 100 and the modem 102 have different manufacturers. Thus, in some examples, the modem 102 outputs KPIs related to a wireless link between the mobile device 100 and a network node, and the KPIs can be stored and processed by the mobile device 100. An example KPI is received signal strength indicator (RSSI) provided by a 3GPP chipset and displayed on the user interface 114 via a “4 coverage bars” icon (e.g., like the “4 coverage bars” icon in most cellphones' screens).

The processing circuitry may include at least one processor 104 (processor), at least one memory 112 (memory). The processor 104 is operationally connected to the various components in FIG. 1. The memory 112 stores executable instructions that are executed by the processor 104 to perform operations. The processor 104 may include one or more data processing circuits, such as a general purpose and/or special purpose processor (e.g., microprocessor and/or digital signal processor), which may be collocated or distributed across one or more data networks. The processor 104 is configured to execute the instructions in the memory 112, described herein as a computer readable medium, to perform some or all of the operations and methods for one or more of the embodiments disclosed herein for a mobile device.

Certain mobile devices 100 may utilize all or a subset of the components shown in FIG. 1. The level of integration between the components may vary from one mobile device 100 to another mobile device 100. Further, certain mobile devices 100 may contain multiple instances of a component, such as multiple processors, memories, antennas, transceivers, transmitters, receivers, etc.

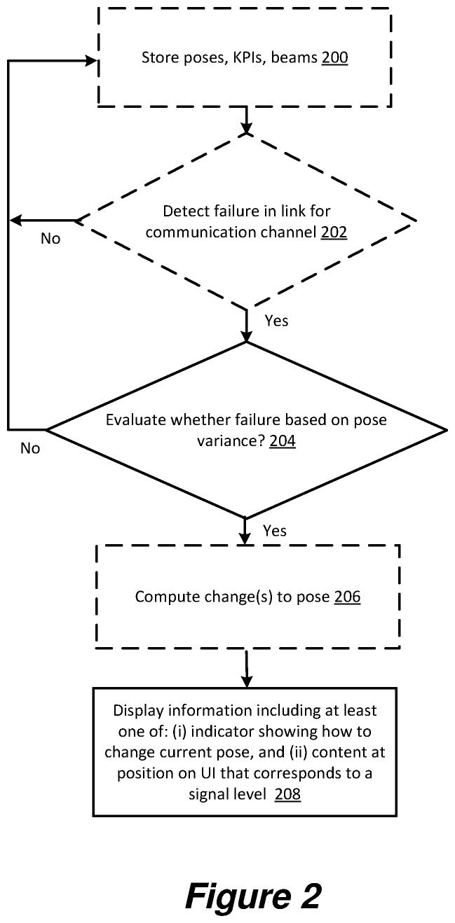

Operations of the mobile device 100 are discussed with reference to the flow chart of FIG. 2 according to some embodiments. For example, modules may be stored in memory 112 of mobile device 100, and these modules may provide instructions so that when the instructions of a module are executed by a respective mobile device 100 at processor 104, the processor 104 performs respective operations of the flow chart.

Some embodiments are directed to a method performed by a mobile device for evaluating and displaying information for an improved communication channel between the mobile device and a network node. The method includes evaluating (operation 204 in FIG. 2) whether a decrease in a quality of the communication channel is based on a first variance of a first signal that indicates a variance in the quality of the communication channel and a second variance of a second signal that indicates a variance in a pose of the mobile device, wherein the first variance and the second variance vary together. The method further includes displaying (operation 208 in FIG. 2), on a user interface of the mobile device, the information including at least one of (i) an indicator showing how to change a current pose of the mobile device, and (ii) a position for the mobile device that satisfies a specified quality for content to be displayed on the user interface of the mobile device in the position. The specified quality for the content can be a bandwidth or other KPI that depends on an application being run on/for the mobile device.

In some embodiments, the pose includes a position and/or an orientation of the mobile device.

Referring to operation 200 in FIG. 2, some embodiments further include storing (i) a plurality of poses of the mobile device, and (ii) a plurality of key performance indicators, KPIs, related to the quality of the communication channel. Respective poses from the plurality of poses are associated with at least one respective KPI related to the quality of the communication channel.

In one example, simultaneous location and mapping (SLAM) operations can be used and include storing of keyframes, such as images taken by a digital camera 106 of the mobile device 100, for which the camera's pose is estimated and by that also the mobile device 100 and antenna/s 108 field of view (FoV). A keyframe can include an associated landmark(s) in the picture; and for each landmark in a keyframe, a measurement of its (two-dimensional (2D) or 3D position can be made. In this example, the landmark(s) is recognized over the span of several keyframes and identified as the same landmark(s). Thus, each landmark has measurements associated with several keyframes. The SLAM operations include globally consistent estimates of a landmark positions and poses based on these measurements.

In some embodiments, a respective pose in the stored plurality of poses is an estimate of the respective pose per a keyframe over a plurality of keyframes based on a measurement of a position of at least one landmark per keyframe.

Additionally or alternatively, measurements from a motion sensor(s) may be integrated in the mobile device 100, e.g., IMU 110 such as a gyroscope, can be used to measure orientation/angular velocity of mobile device 100. Additionally or alternatively, other sensors such as accelerometer, or even a global positioning system (GPS) receiver, can be used to measure the position of the mobile device 100.

In some embodiments, a respective pose in the stored plurality of poses is based on a measurement from a sensor of the mobile device that is used to measure a position of the mobile device.

Further in this example, at the time of processing the keyframe/measurements, a set of KPIs are associated with that keyframe/measurements. Example KPIs can include different kinds of coverage metrics, e.g., latency, channel capacity, or synchronization signal reference signal received power (SS-RSRP).

The plurality of KPIs, in some embodiments, include at least one metric of the quality of the communication channel.

KPIs can be based on a most recent value or an average of a short time window, such as since the last keyframe, for example.

Moreover, operations can include storing an index, or related information, associated with a beam that is currently being used and associated with the keyframe. In some embodiments, the storing (operation 200 in FIG. 2) further includes storing an index, or related information associated with a beam that is in use and associated with a respective keyframe in the plurality of keyframes.

Referring to operation 202 in FIG. 2, in some embodiments, the method further includes detecting a failure in a link for the communication channel between the mobile device and the network node.

The term “failure event” is used herein to refer to a variation that decreases the quality of a communication channel between a mobile device and a network node for an application/action performed by the mobile device and is not limited to a complete failure of the communication channel. Instead, a failure event includes decreases in the quality, as well as failures, and the failure event may vary depending on the application/action. For example, a first application may have different requirements than a second application and, therefore, what is considered a failure event for the first application may not be a failure event for the second application.

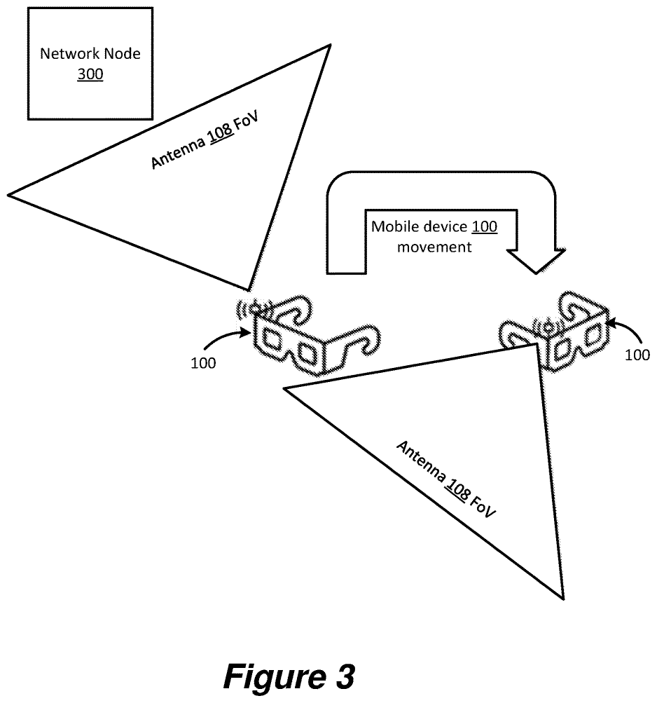

In an example, operation 202 addresses a failure event of an aspect of a wireless link between the mobile device 100 and a network node (e.g., network node 300 in FIG. 3 discussed further herein).

Movements of the mobile device 100 in an environment and/or head motions by a user of the mobile device 100 may cause conditions of a wireless link between the mobile device 100 and a network node to change. For example, movement of the mobile device 100 may result in a substantial increase of a path loss of the wireless link such that, after such path loss increase, reliable communication between the mobile device 100 and the network node cannot be performed.

This may occur, for example, as illustrated in the example in FIG. 3. FIG. 3 illustrates a head motion executed by the user of the mobile device 100 that causes an antenna panel 108, which may be embedded at a location in the mobile device 100 and performs communication with the network node 300 (e.g., a gNodeB (gNB), to face a direction where a reliable propagation path towards/from the network node 300 can be found. As shown in the example in FIG. 3, head movement of a user on a position of the mobile device 100, including the position of antenna(s) 108, can have an effect on the field of view of the antenna(s) 108. Operations of the present disclosure can estimate and accommodate the effect.

At least one processor 104 of the mobile device 100 can detect a failure event in a wireless link between the mobile device 100 and a network node.

In an example, a failure event can be identified when a type of measured signal strength, or equivalent metric, such as a SS-RSRP falls below a threshold. It is noted that a type of measured signal strength for cell coverage information is provided, for example, by a mobile chipset for some cellphones as four “coverage bars” in the display of a cellphone.

In some embodiments, the detecting (operation 202 in FIG. 2) includes the failure is identified based on a metric related to signal strength of the link falling below a threshold value.

In another example, a failure event can be identified if a 3GPP-related beam-failure or radio-link failure is declared by a modem chipset 102 (e.g., a 3GPP modem chipset in this example) of the mobile device 100. It is noted that in this example, there is a dedicated interconnection and information sharing between the modem 102 and the processor 104, so that the processor 104 has access to specific 3GPP events triggered in the modem chipset 102. In other examples, such information may not include detection of a 3GPP failure event and, instead, can be more detailed information such as an index and direction of the failed beam, timestamps, etc.

Examples of 3GPP failure events include, without limitation, the following:
A radio-link failure which may be activated if a mobile device 100 loses coverage to an existing serving cell, in which case the connectivity may need to be re-established. This can occur, for example, if the mobile device 100 fails to hear a synchronization signal block (SSB) of the cell is currently associated with the mobile device 100.
A beam failure which can be declared when a metric of a reference signal (RS), that is exchanged between a network node and the mobile device 100 via an established beam pair, falls below a threshold. For example, when a Layer 1-RSRP (L1-RSRP) measurement of a periodic channel state information (CSI)-RS reception falls below a threshold. This can happen, for example, even if the mobile device 100 is still within a coverage area of the serving cell but is oriented in a way that the current beam used to receive a physical downlink control channel (PDCCH) transmission fails.

While some examples herein are discussed in the context of a 3GPP failure event, the present disclosure is not so limited. Instead, other types of failure events are included, including without limitation, failure events according to other standards such as WiFi, and a failure event that results in degradation of quality of a communication channel between a mobile device and a network node.

In some embodiments, the detecting (operation 202 in FIG. 2) includes the failure is identified based on an identified failure event.

Operation 206 in FIG. 2 identifies whether the failure event in operation 204 of FIG. 2 is based on a change of pose of the mobile device 100. It is noted that, in the absence of a controlled study, causation may not be demonstrated statistically. Instead, in such circumstances, without carrying out a controlled study, statistical methods which are related, but not equivalent, to causation may be used, as discussed further herein.

In an example, in order to detect whether the failure event in operation 202 of FIG. 2 was based on a change of pose from the mobile device 100, the mobile device 100 can track and co-process (1) a coverage metric signal across time, as well as (2) an estimation of a pose in or near real-time based on a measurement(s) from a sensor(s) (e.g., from IMU 110). In some embodiments, for example, the first signal includes a coverage metric signal, the second signal includes information related to motion of the mobile device, and the evaluating (operation 204 of FIG. 2) includes tracking and co-processing (i) the coverage metric signal over a time period, and (ii) the information related to motion of the mobile device over the time period.

In the above example, at a time instance, if the tracked coverage metric signal indicates lack of coverage, the mobile device 100 may inspect the estimation of the pose based on the measurement(s) from a sensor(s) (e.g., from IMU 110) at a time instance and decide whether the lack of coverage was based on a pose motion. For example, at a certain time instance, t₁, a coverage metric drops below a pre-defined acceptable coverage threshold φ_{c}. The mobile device 100 can then compute if the mobile device's 100 pose changed significantly at that time instance, e.g., via computing a rate of change of the pose, or a first derivate, at t₁. If the pose changed significantly at time instance t₁, e.g., the first derivate at t₁ is larger or smaller than a second pre-defined threshold

$${ϕ}_{P}^{′} ,$$

the mobile device 100 can conclude that the failure event was due to a change of pose, and then proceed to operation 206 of FIG. 2.

In some embodiments, the information related to motion of the mobile device includes motion that resulted in the current pose of the mobile device, the coverage metric signal indicates a lack of coverage, the evaluating (operation 204 of FIG. 2) includes deciding whether the lack of coverage occurred at about the time of the motion that resulted in the current pose of the mobile device.

In another example, the mobile device 100 can track a coverage metric signal, e.g. a real function c(t). At a time instance, t₁, the tracked coverage metric signal indicates lack of coverage. The mobile device 100 can then inspect the information related to motion of the mobile device 100 (e.g., the measurement(s) from a sensor/IMU 110) at the time instance. A function can be denoted p(t) which includes the mobile device's 100 pose orientation as a function of time, where 180°>p(t)>−180° ∀t. The mobile device 100 can then estimate a version of an empirical cross-correlation function between c(t) and p(t) around t₁, namely c* [symbol] , or normalize the functions c(t) and p(t) to a zero mean and variance of one (1). In other words, in an example, the mobile device 100 can compute:

$$c ⋆ \text{?} = {\int }_{{t}_{1} - δ}^{{t}_{1} + δ} c ( t ) p ( t + τ ) d t ,$$

Where the window parameter δ can be chosen at will. In one example, the window parameter can be chosen as half of the coherence time of the channel. In another example, the window parameter can be chosen as the time it takes for large scale channel statistics (e.g., path loss) to change significantly. The mobile device 100 can then analyze c* [symbol] at lag 0, c* [symbol] and decide that the lack of coverage was caused by the pose change if, e.g. the absolute value of c* [symbol] is below a pre-defined acceptable threshold

$${ϕ}_{C}^{′} .$$

That is, the mobile device 100 decides that the lack of coverage was caused due to a pose change if:

$$\vert c ⋆ \text{?} \vert > {ϕ}_{C}^{′} .$$

In some embodiments, the first signal includes a coverage metric signal, the second signal includes information related to motion of the mobile device, and the evaluating (operation 202 of FIG. 2) includes tracking the coverage metric signal over a first time period; determining that, around a time instance in the first time period, the tracked coverage metric signal indicates a lack of coverage; inspecting the information related to motion at the time instance; computing a cross-correlation function or a normalized cross-correlation function between the coverage metric signal and the information related to motion for a second time period around the time instance; and deciding whether the lack of coverage occurred at about the time instance as a motion that resulted in the current pose of the mobile device.

Referring to operation 206 of FIG. 2, in some embodiments, the method further includes computing (206) how to change the current pose of the mobile device to improve the quality of the communication channel.

For example, when a beam failure is detected due to a KPI(s), a stored keyframe(s)/pose information and associated KPI(s) are searched to find a set of qualifying keyframe(s)/pose(s) where the KPIs indicate better performance. This can be, for example, all keyframes where the KPI exceeds a specific value, e.g., SS-RSRP indicates “4 bars” or a round trip latency is less than 15 ms.

Further, in this example, as each such keyframe corresponds to a pose in a SLAM created map, a distance to the current pose can be calculated. Among these qualifying keyframes, a desirable/candidate pose can be chosen as the pose with a minimum distance.

In another example, a set of qualifying keyframes that satisfy a distance threshold are all defined as belonging to a set of desirable/candidate poses.

In some embodiments, the computing (operation 206 in FIG. 2) includes: searching (i) a plurality of stored keyframes and/or a plurality of stored poses, and (ii) a plurality of stored key performance indicators, KPIs, representing the quality of the communication channel to find a subset of the plurality of the stored keyframes and/or a subset of the plurality of stored poses where a subset of the plurality of stored KPIs respectively indicate improved performance of the quality of the communication channel, calculating a plurality of distances from the current pose of the mobile device to a plurality of candidate changes to the pose, wherein the calculating is performed from the current pose to respective keyframes in the subset of the plurality of stored keyframes and/or for respective poses in the subset of the plurality of stored poses, and selecting one of (i) a distance having a minimum distance from the calculated plurality of distances, and (ii) a set of the plurality of stored keyframes for a set of candidate poses that satisfy a distance threshold.

If a software for routing is available and the distances to the qualifying keyframes is large, the routing software can be used to, instead of calculating distances using Euclidian geometry, use a time indicated by the routing software to select a path (e.g., a shortest path, fastest path, etc.) that satisfies a specified KPI (e.g., a path that allows for streaming 25 Mbps).

In another example, the mobile device 100 can gather local data and, based on the gather local data, compose an understanding of what signal change a certain movement can have. This information may be used in operation 208 of FIG. 2 to suggest a change in the movement of the mobile device 100 to try to ensure an appropriate signal level to the mobile device 100. In other words, to predict/estimate what will happen with the signal when a certain movement of the mobile device 100 is started, to stop that movement, or to take measures in an application to try to address reduction/alteration of content or quality of experience.

In some embodiments, for example, the computing (operation 206 of FIG. 2) includes building a map for the mobile device of a first plurality of poses that satisfy a KPI representing the quality of the communication channel and a plurality of poses of that fail to satisfy the KPI.

Referring to operation 208 in FIG. 2, in some embodiments, the indicator showing how to change the current pose of the mobile device to improve the quality of the communication channel includes at least one of (i) a mark rendered on the user interface, (ii) a marked area rendered on the user interface, and (ii0) a marking rendered proximate an edge of a field of view on the user interface that indicates a direction of movement to implement the change of the pose.

In some examples, the UI 114 of mobile device 100 adapts itself with additional content positioned on the UI 114 in relation to a field of view of an antenna 108 of the mobile device 100 or additional content to direct a user of the mobile device 100 to a position (e.g., a position in which to stand with the mobile device 100). This information from the mobile device 100 can be provided to a controller and can be input to an application running on/for the mobile device 100. For example, a menu may be positioned on the UI so that a correct azimuth and angle is achieved in relation to an antenna 108 field of view of the mobile device 100. In another non-limiting example, a virtual object can be placed in a position so that a user of the mobile device 100 needs to move to obtain access.

In a further example, operation 208 indicates to a wearer of the mobile device 100 how to change position and orientation to achieve a better KPI for the mobile device 100. If the desirable position is within the field of view of the mobile device 100, an indicator such as an “x” marking is rendered on ground where the user should stand, for example. If a set of desirable/candidate poses includes many points, a colored area, e.g., “green”, can be used to indicate an area to which the mobile device 100 can be moved, for example.

To indicate a correct orientation, a marking (e.g., “*”), can be displayed on a user interface of the mobile device 100 relative to the current position of the mobile device 100, but with the desirable/candidate orientation being marked at a corresponding azimuth and elevation angles.

If the markings are not in the field of view of the mobile device 100, the indicator can be shown projected to the edge of the field of view, e.g., as a green light, to indicate in which direction to move the mobile device 100/look with the mobile device 100.

In yet another example, a user interface of the mobile device 100 can display/place content (e.g., a video) that needs a specified cellular bandwidth at a position in a 3D volume of the user interface that may correspond to a signal level needed from a network node.

In a further example, additional content can be added to a view of the user interface of the mobile device 100 to navigate to or to encourage or force a user of the mobile device 100 to turn in a direction to try to achieve an appropriate signal level to accommodate an application that is to be run or is running on or for the mobile device 100.

In some embodiments, for example, the displaying (operation 208 of FIG. 2) further includes the UI adapting itself (i) with additional content positioned on the UI 114 in relation to a field of view of an antenna 108 of the mobile device 100, or (ii) additional content to direct the mobile device 100 to a position.

In some embodiments, the mobile device includes at least one of (i) an XR device, (ii) an AR device, and (iii) a VR device. Mobile devices of the present disclosure, however, are not limited to XR, AR, or VR headsets/glasses, as they could be a personal computer, tablet computer, smart phone, or other electronic device which can be operated by a user to view and navigate through the XR, AR, or VR environment.

Various operations from the flow chart of FIG. 2 may be optional with respect to some embodiments of mobile devices and related methods. For example, operations of blocks 200, 202, and 206 of FIG. 2 may be optional.

The operations of FIG. 2 may be executed at one processor 104, or equivalent circuit, having access to (1) information on the radio link between the mobile device 100 and a network node, as well as (2) information on pose and/or motion of the mobile device 100, such as IMU information, global navigation satellite system (GNSS), camera, lidar, network positioning, etc. Such a processor, or equivalent circuit, can be in a processor (processor 104 as shown in FIG. 1) which is embedded in mobile device 100 ASICs, network node infrastructure, cloud, etc. In another example, different operations in FIG. 2 may be executed at (physically) different and/or distributed process.

An example communication system includes a telecommunication network that includes an access network, such as a radio access network (RAN), and a core network, which includes one or more core network nodes. The access network can include one or more access network nodes, such as network node 300 of FIG. 3 (e.g., a 3GPP access node or non-3GPP access point). A network node 300 facilitates direct or indirect connection of a mobile device 100, such as by connecting mobile device 100 to the core network over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system may include any number of wired or wireless networks, network nodes, mobile devices, and/or any other components or systems that may facilitate or participate in the communication of data and/or signals whether via wired or wireless connections. The communication system may include and/or interface with any type of communication, telecommunication, data, cellular, radio network, and/or other similar type of system.

As previously referenced herein, a mobile device 100 may be any of a wide variety of mobile devices, including wireless devices arranged, configured, and/or operable to communicate wirelessly with the network nodes 300 and other communication devices. Similarly, the network nodes 300 are arranged, capable, configured, and/or operable to communicate directly or indirectly with the mobile device 100 and/or with other network nodes or equipment in the telecommunication network to enable and/or provide network access, such as wireless network access.

As discussed, the mobile device 100 and the network node are communicatively connected via a communication channel. In that sense, the communication channel may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication channel is part of a cellular network that implements 3GPP standardized features. Accordingly, a telecommunications network that includes the mobile device 100 and network node may support network slicing to provide different logical networks to different devices that are connected to the telecommunication network. For example, the telecommunications network may provide Ultra Reliable Low Latency Communication (URLLC) services to some mobile devices, while providing Enhanced Mobile Broadband (eMBB) services to other mobile devices, and/or Massive Machine Type Communication (mMTC)/Massive IoT services to yet further mobile devices.

In some examples, a mobile device 100 is configured to transmit and/or receive information without direct human interaction. For instance, a mobile device 100 may be designed to transmit information to an access network on a predetermined schedule, when triggered by an internal or external event, or in response to requests from the access network. Additionally, a mobile device 100 may be configured for operating in single- or multi-radio access technology (RAT) or multi-standard mode. For example, a mobile device 100 may operate with any one or combination of Wi-Fi, NR, and LTE, i.e. being configured for multi-radio dual connectivity (MR-DC), such as E-UTRAN (Evolved-UMTS Terrestrial Radio Access Network) New Radio—Dual Connectivity (EN-DC).

Referring to FIG. 12, modem 102 includes components needed to enable a wireless interface with a network node (for example, a cellular base station, WiFi base station, or other network node for other wireless communication standards). The modem 102 is used to send and receive data to and from an application that is used in the mobile device 100. The application can be a game, social media application, map application, etc. The modem 102 can include, e.g., a 3GPP chipset which provides a limited set of link KPIs to the mobile device 100.

Mobile device 100 may include one or more antennas 108 for communication with a network node (e.g., network node 300 in FIG. 3). The antenna(s) 108 can transmit and receive data, and can include at least one antenna element that is connected to the modem 102. Antenna elements 108 can be placed in one or multiple places in the mobile device 100.

Processor 104 can process data that is received from the modem 102 and can prepare data that can be transmitted. Processor 104 also can run at least one application in the mobile device 100.

Memory 112 can be used to store data that is received, data that can be transmitted, and data that is calculated, stored, and/or used for the processor 104 to function, etc. The memory 112 can be organized in at least one hierarchy. Memory 112 technology includes, without limitation, static random access memory (SRAM), dynamic random access memory (DRAM), etc. or any combination thereof.

IMU 110 that can at least sense or measure movement of the mobile device 100 in multiple dimensions. IMU 110 can include or be replaced by a sensor(s) that can give sensor input of the motion of the mobile device 100. Examples of such technologies include, without limitations, visual odometry.

Camera 106 can determine the surroundings of the mobile device 100 and take decisions based on the data. The camera 106 can be replaced or supported by other sensors, such as lidar, radar, time of flight (ToF) camera, GNSS, etc.

As previously discussed, FIG. 3 shows a network node 300 in accordance with some embodiments. As used herein, network node refers to equipment capable, configured, arranged and/or operable to communicate directly or indirectly with a mobile device and/or with other network nodes or equipment, in a communication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node can include a processing circuitry, a memory, a communication interface, and a power source. The network node may be composed of multiple physically separate components (e.g., a NodeB component and a RNC component, or a BTS component and a BSC component, etc.), which may each have their own respective components. In certain scenarios in which the network node comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ200 may be configured to support multiple RATs. In such embodiments, some components may be duplicated (e.g., separate memory for different RATs) and some components may be reused (e.g., a same antenna may be shared by different RATs). The network node may also include multiple sets of the various of the components for different wireless technologies integrated into network node, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within a network node.

Functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments hosted by one or more of hardware nodes, such as a hardware computing device that operates as a mobile device, network node, core network node, or host. Further, in embodiments in which the virtual node does not require radio connectivity (e.g., a core network node or host), then the node may be entirely virtualized.

Applications (which may alternatively be called software instances, virtual appliances, network functions, virtual nodes, virtual network functions, etc.) are run in the virtualization environment to implement some of the features, functions, and/or benefits of some of the embodiments disclosed herein.

Although the mobile devices described herein (e.g., XR, AR, VR headsets or glasses) may include the illustrated combination of hardware components, other embodiments may comprise mobile devices with different combinations of components. It is to be understood that these mobile devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, mobile devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the mobile device, but are enjoyed by the mobile device as a whole, and/or by end users and a wireless network generally.

In the above-description of various embodiments of the present disclosure, it is to be understood that the terminology used herein is for the purpose of describing particular embodiments only and is not intended to be limiting on the present disclosure. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present disclosure.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of the present disclosure. Accordingly, the above disclosed subject matter is to be considered illustrative, and not restrictive, and the appended examples of embodiments are intended to cover all such modifications, enhancements, and other embodiments, which fall within the spirit and scope of the present disclosure. Thus, to the maximum extent allowed by law, the scope of the present disclosure is to be determined by the broadest permissible interpretation of the present disclosure including the following examples of embodiments and their equivalents, and shall not be restricted or limited by the foregoing detailed description.

1. A method performed by a mobile device for evaluating and displaying information for an improved communication channel between the mobile device and a network node, the method comprising:
evaluating whether a decrease in a quality of the communication channel is based on a first variance of a first signal that indicates a variance in the quality of the communication channel and a second variance of a second signal that indicates a variance in a pose of the mobile device, wherein the first variance and the second variance vary together; and
displaying, on a user interface of the mobile device, the information comprising at least one of (i) an indicator showing how to change a current pose of the mobile device, and (ii) a position for the mobile device that satisfies a specified quality for content to be displayed on the user interface of the mobile device in the position.

2. The method of claim 1, wherein the pose comprises a position and/or an orientation of the mobile device.

3. The method of claim 1, further comprising:
storing a plurality of poses of the mobile device, and (ii) a plurality of key performance indicators, KPIs, related to the quality of the communication channel, wherein respective poses from the plurality of poses are associated with at least one respective KPI related to the quality of the communication channel.

4. The method of claim 3, wherein a respective pose in the stored plurality of poses is an estimate of the respective pose per a keyframe over a plurality of keyframes based on a measurement of a position of at least one landmark per keyframe.

5. The method of claim 3, wherein a respective pose in the stored plurality of poses is based on a measurement from a sensor of the mobile device that is used to measure a position of the mobile device.

6. The method of claim 3, wherein the plurality of KPIs comprise at least one metric of the quality of the communication channel.

7. The method of claim 4, wherein the storing further comprises storing an index, or related information associated with a beam that is in use and associated with a respective keyframe in the plurality of keyframes.

8. The method of claim 1, further comprising:
detecting a failure in a link for the communication channel between the mobile device and the network node.

9. The method of claim 8, wherein the detecting comprises the failure is identified based on a metric related to signal strength of the link falling below a threshold value.

10. The method of claim 8, wherein the detecting comprises the failure is identified based on an identified failure event.

11. The method of claim 1, wherein the first signal comprises a coverage metric signal, the second signal comprises information related to motion of the mobile device, and the evaluating comprises:
tracking and co-processing (i) the coverage metric signal over a time period, and (ii) the information related to motion of the mobile device over the time period.

12. The method of claim 11, wherein the information related to motion of the mobile device comprises motion that resulted in the current pose of the mobile device, the coverage metric signal indicates a lack of coverage, the evaluating comprises deciding whether the lack of coverage occurred at about the time of the motion that resulted in the current pose of the mobile device.

13. The method of claim 1, wherein the first signal comprises a coverage metric signal, the second signal comprises information related to motion of the mobile device, and the evaluating comprises:
tracking the coverage metric signal over a first time period,
determining that, at a time instance in the first time period, the tracked coverage metric signal indicates a lack of coverage,
inspecting the information related to motion around the time instance,
computing a cross-correlation function or a normalized cross-correlation function between the coverage metric signal and the information related to motion for a second time period around the time instance, and
deciding whether the lack of coverage occurred at about the time instance as a motion that resulted in the current pose of the mobile device.

14. The method of claim 1, further comprising:
computing how to change the current pose of the mobile device to improve the quality of the communication channel.

15. The method of claim 14, wherein the computing comprises:
searching (i) a plurality of stored keyframes and/or a plurality of stored poses, and (ii) a plurality of stored key performance indicators, KPIs, representing the quality of the communication channel to find a subset of the plurality of the stored keyframes and/or a subset of the plurality of stored poses where a subset of the plurality of stored KPIs respectively indicate improved performance of the quality of the communication channel, and
calculating a plurality of distances from the current pose of the mobile device to a plurality of candidate changes to the pose, wherein the calculating is performed from the current pose to respective keyframes in the subset of the plurality of stored keyframes and/or for respective poses in the subset of the plurality of stored poses, and
selecting one of (i) a distance having a minimum distance from the calculated plurality of distances, and (ii) a set of the plurality of stored keyframes for a set of candidate poses that satisfy a distance threshold.

16. The method of claim 14, wherein the computing comprises building a map for the mobile device of a first plurality of poses that satisfy a key performance indicator, KPI, representing the quality of the communication channel and a plurality of poses of that fail to satisfy the KPI.

17-19. (canceled)

20. A mobile device for evaluating and displaying information for an improved communication channel between the mobile device and a network node, the mobile device comprising:
at least one processor; and
at least one memory storing instructions executable by the at least one processor to perform operations to:
evaluate whether a decrease in a quality of the communication channel is based on a first variance of a first signal that indicates a variance in the quality of the communication channel and a second variance of a second signal that indicates a variance in a pose of the mobile device, wherein the first variance and the second variance vary together; and
display, on a user interface of the mobile device, the information comprising at least one of (i) an indicator showing how to change a current pose of the mobile device, and (ii) a position for the mobile device that satisfies a specified quality for content to be displayed on the user interface of the mobile device in the position.

21. The mobile device of claim 20, wherein the at least one memory stores further instruction executable by the at least one processor to perform further operations comprising evaluating and displaying information for an improved communication channel between the mobile device and a network node, the method comprising:
evaluating whether a decrease in a quality of the communication channel is based on a first variance of a first signal that indicates a variance in the quality of the communication channel and a second variance of a second signal that indicates a variance in a pose of the mobile device, wherein the first variance and the second variance vary together; and
displaying, on a user interface of the mobile device, the information comprising at least one of (i) an indicator showing how to change a current pose of the mobile device, and (ii) a position for the mobile device that satisfies a specified quality for content to be displayed on the user interface of the mobile device in the position, wherein the pose comprises a position and/or an orientation of the mobile device.

22. A computer program product comprising a non-transitory computer readable medium storing instructions executable by at least one processor of a mobile device for evaluating and displaying information for an improved communication channel between the mobile device and a network node, the instructions executed by the at least one processor perform operations comprising:
evaluate whether a decrease in a quality of the communication channel is based on a first variance of a first signal that indicates a variance in the quality of the communication channel and a second variance of a second signal that indicates a variance in a pose of the mobile device, wherein the first variance and the second variance vary together; and
display, on a user interface of the mobile device, the information comprising at least one of (i) an indicator showing how to change a current pose of the mobile device, and (ii) a position for the mobile device that satisfies a specified quality for content to be displayed on the user interface of the mobile device in the position.

23. The computer program product of claim 22, wherein the non-transitory computer readable medium stored further instruction executable by at least one processor of the mobile device, the further instructions executed by the at least one processor to perform further operations comprising evaluating and displaying information for an improved communication channel between the mobile device and a network node, the method comprising:
evaluating whether a decrease in a quality of the communication channel is based on a first variance of a first signal that indicates a variance in the quality of the communication channel and a second variance of a second signal that indicates a variance in a pose of the mobile device, wherein the first variance and the second variance vary together; and
displaying, on a user interface of the mobile device, the information comprising at least one of (i) an indicator showing how to change a current pose of the mobile device, and (ii) a position for the mobile device that satisfies a specified quality for content to be displayed on the user interface of the mobile device in the position, wherein the pose comprises a position and/or an orientation of the mobile device.
